(19) United States
(12) Patent Application Publication
(10) Pub. No.: US 2009/0124260 A1
(43) Pub. Date: May 14, 2009

(54) Method of providing session establishment information in multiple wireless communication systems

(76) Inventors: Alessio Casati, Swindon (GB); Said Tatesh, Swindon (GB); Sudeep Kumar Palat, Swindon (GB)

Correspondence Address: Docket Administrator - Room 2F-192;Alcatel-Lucent USA Inc., 600-700 Mountain Avenue, Murray Hill, NJ, 07974, US

(21) Appl. No.: 12/221,888

(22) Filed: Aug. 7, 2008

(30) Foreign Application Priority Data
Feb. 7, 2006 (EP) 0602402.0
Feb. 5, 2007 (EP) 07763566.2

(51) Int. Cl. H04W 36/00

(52) U.S. Cl. 455/436

(57) ABSTRACT

The present invention provides methods involving at least one mobile unit configured to receive wireless connectivity using first and second wireless communication systems that operate according to first and second radio interface technologies, respectively. The first and second radio interface technologies are different. The method may include determining, in response to the mobile unit handing off from the first to the second wireless communication system, session establishment information for the second wireless communication system based on session establishment information associated with the first wireless communication system.

### BACKGROUND OF THE INVENTION

1. Field of the Invention

This invention relates generally to communication systems, and, more particularly, to wireless communication systems.

2. Description of the Related Art

Wireless communication systems typically include one or more base stations or access points attached to the wireless communication system for providing wireless connectivity to mobile units in a geographic area associated with each base station or access point. To initiate communication between a mobile unit and the wireless communication system, the mobile unit and the wireless communication system must establish a session. For example, the mobile unit and the base station may negotiate session parameters for a new session. Alternatively, session parameters for an existing session between the mobile unit and a different base station may be transferred to the new base station, e.g., as part of a handover procedure. Once a session has been established between the mobile unit and the base station, the mobile unit and the base station may form a wireless communication link, or air interface, which may be used to transmit modulated radiofrequency signals based on the session parameters. The air interface includes downlink (or forward link) channels for transmitting information from the base station to the mobile unit and uplink (or reverse link) channels for transmitting information from the mobile unit to the base station. The uplink and downlink channels are typically divided into data channels, random access channels, broadcast channels, paging channels, control channels, and the like.

Establishment of the communication session and/or wireless communication link is performed according to wireless communication standards and/or protocols. For example, members of the Third Generation Partnership Project (3GPP, 3GPP2) establish and agree to standards and/or protocols that may then be adopted by service providers for implementing their wireless communication systems. Adopting the agreed-upon standards and/or protocols permits service providers to cooperate in providing wireless communication service to subscribers. However, successive generations of standards and/or protocols are not always completely forward and backward compatible with each other. In particular, some features of the newest standards and/or protocols may conflict with or be incompatible with comparable standards and/or protocols associated with previous, or legacy, standards and/or protocols. Consequently, current and legacy wireless communication systems are not always able to cooperate in providing wireless communication service to subscribers. For example, General Packet Radio Source (GPRS) systems that operate according to the second and/or third generations (2G and 3G/UMTS) of the 3GPP standards and/or protocols may include features that are not directly compatible with subsequent standards and/or protocols, such as the Long Term Evolution/System Architecture Evolution (LTE/SAE) standards and/or protocols under discussion by the 3GPP.

Legacy wireless communication systems utilize contexts to establish sessions for mobile units in the legacy wireless communication system. For example, 2G/3G wireless communication systems use a Packet Data Protocol (PDP) context to define aspects of the session such as routing, quality of service, security, billing, and the like. The PDP context is a logical association between the mobile unit and a public data network running across a GPRS network. Each PDP context includes information such as an associated PDP address, an access point name (APN) that includes routing information, a Quality of Service (QoS) for the session, a network service access point identifier (NSAPI) that is an index to the PDP context that is using services provided by other layers, a transaction identifier (TI) that is used to distinguish multiple bi-directional message flows for a given connection, and the like. The context information associated with each session may be negotiated between the mobile unit and the wireless communication system when the session is established. Alternatively, the context information may be transferred between entities within the wireless communication system, e.g., when the mobile unit and/or the session is handed over from one base station to another base station.

In the real world, wireless connectivity is provided to mobile units using multiple wireless communication systems, some of which may operate according to the most recent standards and/or protocols and some of which may operate according to one or more legacy standards and/or protocols. For example, the LTE/SAE wireless communication system may be initially deployed by overlaying the system with existing 2G/3G/UMTS wireless communication systems. The new and legacy wireless communication systems utilize different radio interface technologies that operate according to different standards and/or protocols. The legacy 2G/3G/UMTS wireless communication systems are expected to be, at least initially, more mature than the new LTE/SAE wireless communication systems and therefore the legacy wireless communication systems are expected to provide, at least initially, better and more reliable coverage. Consequently, mobile units are likely to utilize legacy wireless communication systems when coverage from the new wireless communication system is lost or not available.

The LTE/SAE wireless communication system is not expected to implement PDP contexts or PDP contexts with the same set of parameters for session establishment. To the contrary, current proposals indicate that the LTE/SAE wireless communication system is likely to use a smaller (and different) set of session parameters for establishing sessions with mobile units. Consequently, the currently proposed wireless communication systems may not be able to generate and/or derive the PDP context information for a mobile unit that hands off from an LTE/SAE wireless communication system to a legacy wireless communication system. Furthermore, the proposed LTE/SAE wireless communication system does not include a mechanism for generating, converting, and/or transferring legacy PDP context information to form the smaller (and different) set of session parameters that are used to establish sessions in the LTE/SAE wireless communication system.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided involving at least one mobile unit configured to receive wireless connectivity using first and second wireless communication systems that operate according to first and second radio interface technologies, respectively. The first and second radio interface technologies are different. The method may include determining, in response to the mobile unit handing off from the first to the second wireless communication system, session establishment information for the second wireless communication system based on session establishment information associated with the first wireless communication system.

In another embodiment of the present invention, a method is provided involving at least one mobile unit configured to receive wireless connectivity using first and second wireless communication systems that operate according to first and second radio interface technologies, respectively. The first and second radio interface technologies are different. The method may include providing, from the first wireless communication system to the second wireless communication system and in response to said at least one mobile unit handing off from the first to the second wireless communication system, information indicative of session establishment information for the second wireless communication system.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a communication system, in accordance with the present invention;

FIG. 2 conceptually illustrates a first exemplary embodiment of a method for determining session establishment information, in accordance with the present invention;

FIGS. 3A and 3B conceptually illustrate second and third exemplary embodiments of a method for determining session establishment information, in accordance with the present invention; and

FIGS. 4A and 4B conceptually illustrate fourth and fifth exemplary embodiments of a method for determining session establishment information, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

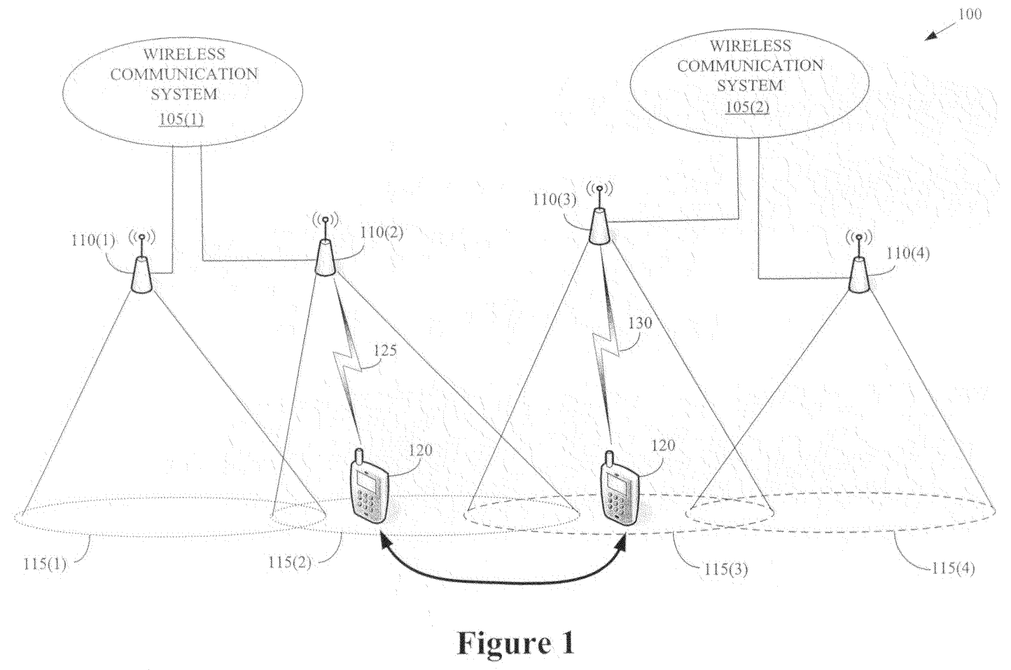

FIG. 1 conceptually illustrates one exemplary embodiment of a communication system 100. In the illustrated embodiment, the communication system 100 includes two wireless communication systems 105(1-2) for providing wireless connectivity. The distinguishing indices (1-2) may be used to indicate individual wireless communication systems 105(1-2) and/or subsets thereof. However, the distinguishing indices (1-2) may be dropped when referring to the wireless communication systems 105 collectively. This convention may also be applied to other elements shown in the drawings and indicated by a numeral and one or more distinguishing indices. Persons of ordinary skill in the art having benefit of the present disclosure should appreciate that the selected number of wireless communication systems 105 is illustrative and that the present invention is not limited to systems 100 that only include two wireless communication systems 105. In alternative embodiments, the communication system 100 may include any number of wireless communication systems 105.

The wireless communication systems 105 operate according to different radio interface technologies. As used herein, the term “radio interface technology” will be understood to refer to the standards and/or protocols that are implemented by the wireless communication systems 105 to provide wireless connectivity, as well as the hardware, firmware, and/or software that are used by the wireless communication systems 105 to implement the standards and/or protocols and provide wireless connectivity. In the illustrated embodiment, the wireless communication system 105(1) operates according to a legacy radio interface technology. As used herein, the term “legacy” refers to radio interface technologies that operate according to standards and/or protocols that have been released and/or deployed prior to the most current radio interface technology. For example, the wireless communication system 105(1) may implement the Second Generation (2G) General Packet Radio Source (GPRS) standards and/or protocols, which have been defined by the Third Generation Partnership Project (3GPP). For another example, a wireless communication system 105(2) may implement the Third Generation (3G) GPRS standards and/or protocols defined by the Third Generation Partnership Project (3GPP). The 3G standards and/or protocols may also be referred to as the Universal Mobile Telecommunication System (UMTS) standards and/or protocols.

The wireless communication system 105(2) operates according to a radio interface technology that differs from the radio interface technology implemented by the wireless communication system 105(1). In the illustrated embodiment, the wireless communication system 105(2) implements the most current (new) radio interface technology. For example, the wireless communication system 105(2) may implement the Long Term Evolution/System Architecture Evolution (LTE/SAE) standards and/or protocols under discussion by the 3GPP. The new radio interface technology implemented by the wireless communication system 105(2) operates according to standards and/or protocols that may not be supported or recognized by legacy radio interface technologies implemented by the wireless communication system 105(1). Similarly, the legacy radio interface technology implemented by the wireless communication system 105(1) operates according to standards and/or protocols that may not be supported or recognized by the new radio interface technology implemented by the wireless communication system 105(2). For example, the new and legacy radio interface technologies may include features that are not forward and/or backward-compatible, as will be discussed in detail below.

The wireless communication systems 105 provide wireless connectivity via one or more base stations 110. However, the present invention is not limited to providing wireless connectivity via base stations 110. In alternative embodiments, the wireless communication systems 105 may provide wireless connectivity via other entities such as access points, access networks, base station routers, and the like. Each of the base stations 110 provides wireless connectivity to a geographic area or cell 115. Although the cells 115 in FIG. 1 are depicted as being approximately circular and at least partially overlapping, the topology of actual cells 115 may be irregular (as well as time varying) and the shapes of the cells 115 may depend upon environmental conditions and the transmission and/or reception parameters adopted by the base stations 110. In one embodiment, the base stations 110 may include directional antennas that permit the base stations 110 to provide wireless connectivity independently and concurrently to one or more sectors within the associated cells 115.

In the illustrated embodiment, a mobile unit 120 has established a wireless communication link 125 with the base station 110(2) in the wireless communication system 105(1). In order to establish the wireless communication link 125, the mobile unit 120 initiates a session with the base station 110(2) and/or another entity in the wireless communication system 105(1), such as a radio network controller (not shown). The mobile unit 120 and the wireless communication system 105(1) may form, exchange, and/or negotiate session establishment information that may be used to establish the session. For example, when the wireless communication system 105(1) operates according to 2G or 3G/UMTS standards and/or protocols, the session establishment information includes a Packet Data Protocol (PDP) context that may be used to define aspects of the session such as routing, quality of service, security, billing, and the like. The PDP context is a logical association between the mobile unit 120 and a public data network running across a GPRS network, such as the wireless communication network 105(1). Each PDP context includes information such as an associated PDP address, an access point name (APN) that includes routing information, a Quality of Service (QoS) for the session, a network service access point identifier (NSAPI) that is an index to the PDP context that is using services provided by other layers, a transaction identifier (TI) that is used to distinguish multiple bi-directional message flows for a given connection, and the like. The PDP context may also be used to establish a radio bearer between the mobile unit 120 and the base station 110(2).

The mobile unit 120 may be handed off between base stations 110 associated with the different wireless communication systems 105. In the illustrated embodiment, the mobile unit 120 is handed off from the base station 110(2) in the wireless communication system 105(1) to the base station 110(3) in the wireless communication system 105(2). Persons of ordinary skill in the art should appreciate that the handoff may be the result of movement of the mobile unit 120 and/or changing environmental or transmission conditions that result in the mobile unit 120, the base stations 110(2-3), and/or entities within the wireless communication systems 105 determining that the mobile unit 120 should be handed off from the base station 110(2) to the base station 110(3). Techniques for handing off the mobile unit 120, as well as determining when the mobile unit 120 should be handed off, are known in the art and in the interest of clarity only those aspects of handing off the mobile unit 120 that are relevant to the present invention will be discussed herein.

As discussed above, the wireless communication systems 105 implement different radio interface technologies. One consequence of implementing the different radio interface technologies that is manifest in the illustrated embodiment is that the wireless communication systems 105 utilize different session establishment information to establish the wireless communication link 130. For example, the wireless communication system 105(1) may use the PDP contexts to establish sessions and/or radio bearers whereas the wireless communication system 105(2) does not utilize PDP contexts. Instead, the wireless communication system 105(2) uses session establishment information that includes different information and/or less information than is included in a PDP context. Utilizing less and/or different information to establish sessions in the wireless communication system 105(2) may simplify the session establishment process and reduce the number of parameters that need to be exchanged and/or negotiated when establishing sessions with the wireless communication system 105(2). However, the PDP contexts associated with session established between the mobile unit 120 and the wireless communication system 105(1) may not be used directly to establish a session with the wireless communication system 105(2), e.g., when the mobile unit is handed off between the wireless communication systems 105. Conversely, the session establishment information utilized by the wireless communication system 105(2) may not be used directly to establish a session with the wireless communication system 105(1).

To facilitate inter-system changes and/or hand offs by the mobile unit 120, the wireless communication systems 105 implement techniques for determining session establishment information for the wireless communication systems 105 based on session establishment information associated with the other wireless communication system 105. For example, when the mobile unit 120 hands off from the wireless communication system 105(1) to the wireless communication system 105(2), the PDP context information associated with the session in the wireless communication system 105(1), as well as other information stored in the wireless communication system 105(1), may be used to determine the session establishment information utilized by the wireless communication system 105(2). The session and/or radio bearer associated with the mobile unit 120 may then be established using the appropriate session establishment information for the wireless communication system 105(2).

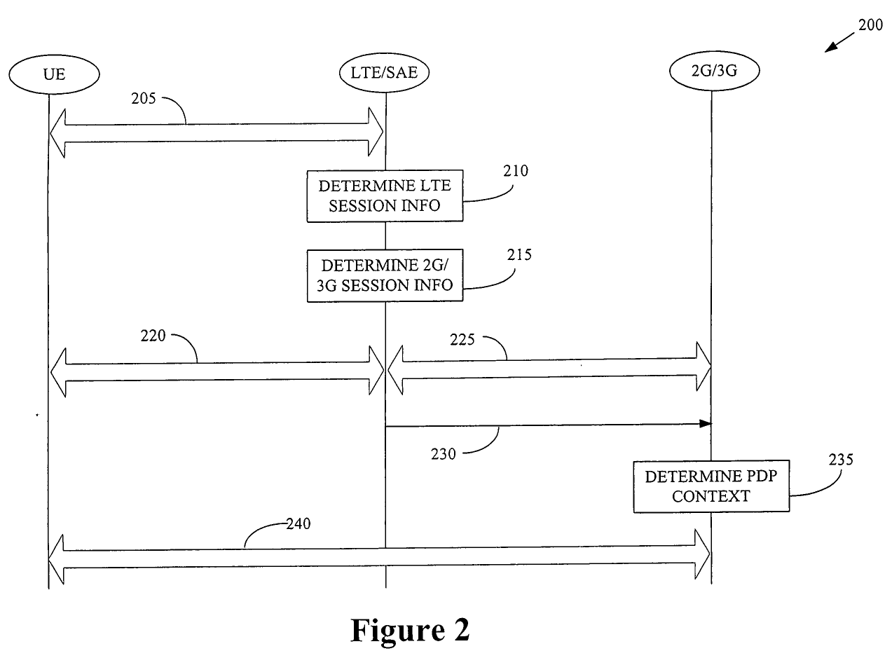

FIG. 2 conceptually illustrates a first exemplary embodiment of a method 200 for determining session establishment information. In the illustrated embodiment, a mobile unit (or user equipment, UE) establishes a session with a wireless communication system that operates according to the LTE/SAE radio interface technology, as indicated by the double arrow 205. The specific messages and/or information that are exchanged by the mobile unit and the LTE/SAE wireless communication system are matters of design choice. The LTE/SAE wireless communication system also determines (at 210) the session establishment information that is used to establish a session with the mobile unit. Although FIG. 2 depicts the determination (at 210) of the session establishment information as occurring after the exchange of messages and information indicated by the arrow 205, persons of ordinary skill in the art having benefit of the present disclosure should appreciate that this determination (at 210) may occur before and/or concurrently with the exchange of messages and/or information indicated by the arrow 205. For example, the session establishment information may be determined (at 210) by negotiations (at 205) between the mobile unit and the LTE/SAE wireless communication system.

The LTE/SAE wireless communication system may then determine (at 215) session establishment information that may be used by a legacy 2G and/or 3G wireless communication system. In one embodiment, the LTE/SAE wireless communication system uses the LTE/SAE session establishment information determined (at 210) to derive or form (at 215) a PDP context that could be used to establish a session in the 2G/3G wireless communication system. The LTE/SAE wireless communication system may also use other information, which may be provided by the mobile unit (at 205) or the LTE/SAE wireless communication system, to determine (at 215) the PDP context associated with the mobile unit. In one embodiment, the PDP contexts may be determined (at 215) in response to the mobile unit establishing (at 205) a session with the LTE/SAE wireless communication system and may then be stored for subsequent use. Alternatively, the LTE/SAE wireless communication system may determine (at 215) the PDP context in response to receiving an indication that the mobile unit is to be handed off to a 2G/3G wireless communication system.

The mobile unit may be handed off between the LTE/SAE wireless communication system and the 2G/3G wireless communication system. In the illustrated embodiment, the signaling, information, and/or messages that are used to perform the handoff of the mobile unit are indicated by the double arrows 220, 225. In response to the mobile unit handing off, the LTE/SAE wireless communication system provides the PDP contexts associated with the mobile unit (or information that may be used to derive the appropriate PDP context) to the 2G/3G wireless communication system, as indicated by the arrow 230. For example, messages defined by a LTE/SAE session management protocol may be used to communicate (at 230) the PDP context information to the 2G/3G wireless communication system.

The 2G/3G wireless communication system may then determine (at 235) the PDP context associated with the mobile unit using the information provided (at 230) by the LTE/SAE wireless communication system. The session between the mobile unit and the 2G/3G wireless communication system may then be established (as indicated by the double arrows 240) using the PDP context information. Although the signaling indicated by the events 220, 225, 230, 235, 240 are depicted in FIG. 2 as occurring sequentially, persons of ordinary skill in the art having benefit of the present disclosure should appreciate that the present invention is not so limited. The particular order of the events 220, 225, 230, 235, 240 is a matter of design choice and, in some embodiments, some or all of the events 220, 225, 230, 235, 240 may take place concurrently.

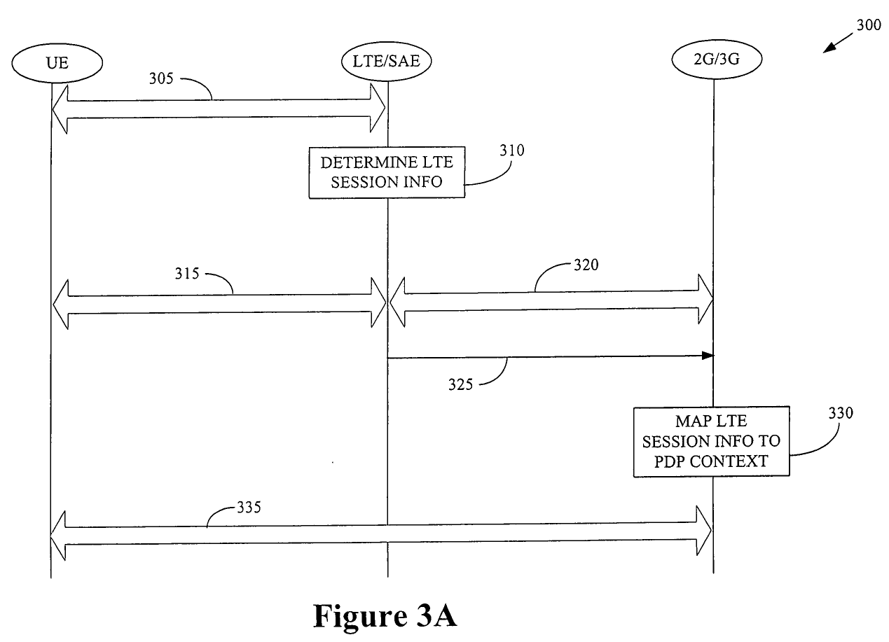

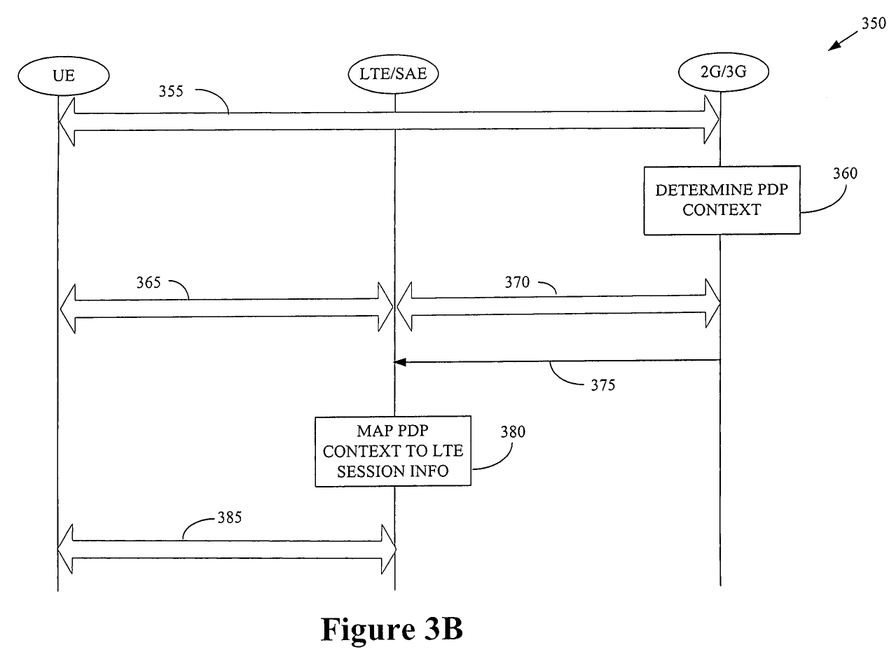

FIG. 3A conceptually illustrates a second exemplary embodiment of a method 300 for determining session establishment information. In the illustrated embodiment, a mobile unit (or user equipment, UE) establishes a session with a wireless communication system that operates according to the LTE/SAE radio interface technology, as indicated by the double arrow 305. The specific messages and/or information that are exchanged by the mobile unit and the LTE/SAE wireless communication system are matters of design choice. The LTE/SAE wireless communication system determines (at 310) the session establishment information that is used to establish a session with the mobile unit. As discussed above, the determination (at 310) may occur before and/or concurrently with the exchange of messages and/or information indicated by the arrow 305, e.g., by negotiations (at 305) between the mobile unit and the LTE/SAE wireless communication system.

The mobile unit may be handed off between the LTE/SAE wireless communication system and the 2G/3G wireless communication system. In the illustrated embodiment, the signaling, information, and/or messages that are used to perform the handoff of the mobile unit are indicated by the double arrows 315, 320. In response to the mobile unit handing off, the LTE/SAE wireless communication system provides the LTE/SAE session establishment information associated with the mobile unit, as well as other information that may be used to derive the appropriate PDP context, to the 2G/3G wireless communication system, as indicated by the arrow 325. For example, messages defined by a LTE/SAE session management protocol may be used to communicate (at 325) the LTE/SAE session establishment information to the 2G/3G wireless communication system.

The 2G/3G wireless communication system may then map (at 330), using specified and/or predetermined transformation rules, the LTE/SAE session establishment information to the PDP context associated with the mobile unit using the information provided (at 325) by the LTE/SAE wireless communication system. The mapping (at 330) allows the radio bearers in the LTE/SAE wireless communication system to be mapped to radio bearers in the 2G/3G wireless communication system. The UE also performs the same mapping using the specified transformation rules. Accordingly, the mapping (at 330) should result in the mobile unit and the 2G/3G wireless communication system having identical session establishment parameters, e.g. as indicated in the associated PDP contexts. As discussed above, some or all of the events 315, 320, 325, 330, 335 may take place concurrently.

In one alternative embodiment, a minimal mapping between the session establishment information used in the LTE/SAE and 2G/3G wireless communication systems could be specified. The specified mapping can be performed (at 330) by the target system (e.g., the 2G/3G wireless communication system) and carried by the source system (e.g., the LTE/SAE wireless communication system) to the mobile unit. For example, the 2G/3G wireless communication system may perform (at 330) the mapping using some basic specified transformation rules. Subsequently, this information could be sent to the mobile unit over the LTE/SAE wireless communication system to synchronize the 2G/3G wireless communication system and the mobile unit. This alternative may provide more flexibility in the mapping since it is done by the network and hence makes it easier to update the transformation rules at a later date. However, this approach may require the mobile unit to re-create the PDP context at change over to the 2G/3G wireless communication system rather than retaining and reusing the sessions. This alternative method could also add some additional delay for the inter-system change but this can be expected to be minimal.

The session between the mobile unit and the 2G/3G wireless communication system may then be established (as indicated by the double arrows 335) using the PDP context information derived from the information provided by the LTE/SAE wireless communication system. Although the signaling indicated by the events 315, 320, 325, 330, 335 are depicted in FIG. 3 as occurring sequentially, persons of ordinary skill in the art having benefit of the present disclosure should appreciate that the present invention is not so limited. The particular order of the events 315, 320, 325, 330, 335 is a matter of design choice and, in some embodiments, some or all of the events 315, 320, 325, 330, 335 may take place concurrently.

FIG. 3B conceptually illustrates a third exemplary embodiment of a method 350 for determining session establishment information. The third exemplary embodiment is similar to the second exemplary embodiment, except that the mobile unit initially has established (at 355) a session with the 2G/3G wireless communication system using a determined (at 360) PDP context and is subsequently handed off (at 365, 370) to the LTE/SAE wireless communication system. In response to the mobile unit handing off, the 2G/3G wireless communication system provides the 2G/3G session establishment information (e.g., the PDP context) associated with the mobile unit, as well as other information that may be used to derive the appropriate session establishment information for the LTE/SAE wireless communication system, to the LTE/SAE wireless communication system, as indicated by the arrow 375. The LTE/SAE wireless communication system may then map (at 380) the 2G/3G session establishment information to the LTE/SAE session establishment information associated with the mobile unit using the information provided (at 375) by the 2G/3G wireless communication system, using techniques analogous to those discussed above with regard to FIG. 3A. The session between the mobile unit and the LTE/SAE wireless communication system may then be established (as indicated by the double arrows 385) using the LTE/SAE session establishment information.

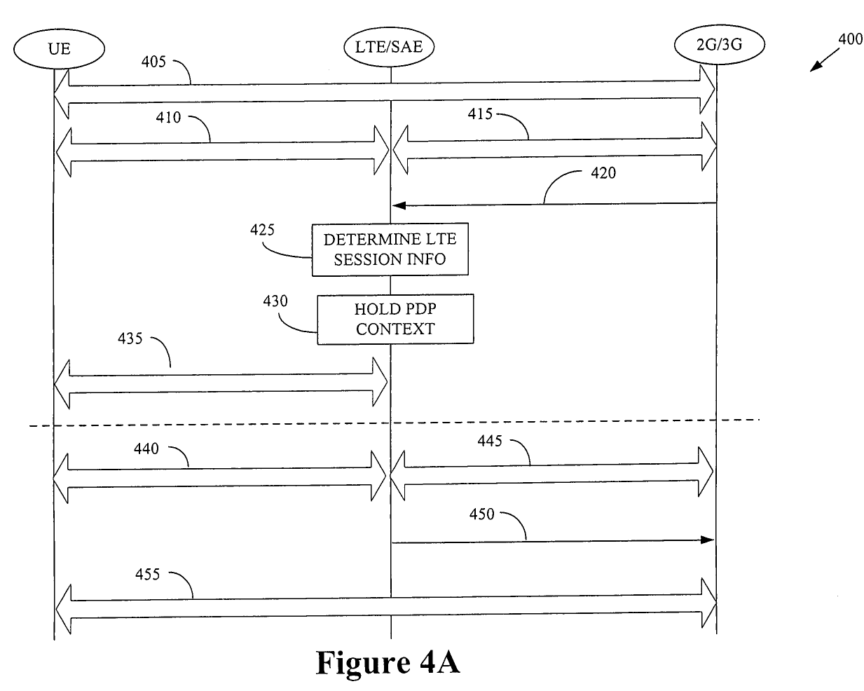

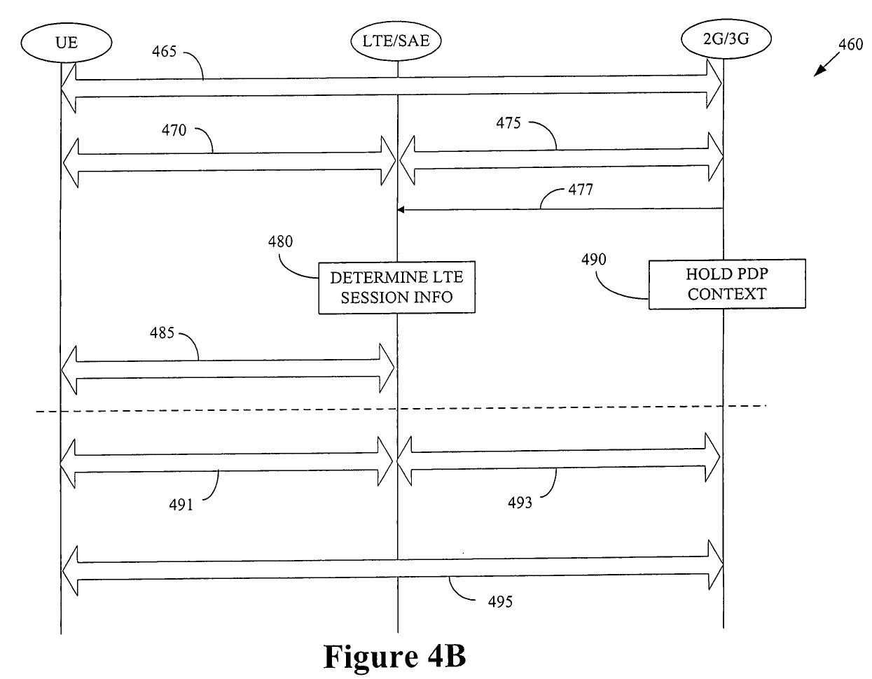

FIG. 4A conceptually illustrates a fourth exemplary embodiment of a method 400 for determining session establishment information. In the illustrated embodiment, a mobile unit (or user equipment, UE) establishes a session with a wireless communication system that operates according to the legacy 2G/3G radio interface technology, as indicated by the double arrow 405. The mobile unit is subsequently handed off (at 410, 415) to the LTE/SAE wireless communication system. In response to the mobile unit handing off, the 2G/3G wireless communication system provides the 2G/3G session establishment information (e.g., the PDP context) associated with the mobile unit to the LTE/SAE wireless communication system, as indicated by the arrow 420. The LTE/SAE wireless communication system then determines (at 425) the appropriate session establishment information using the provided 2G/3G session establishment information. The LTE/SAE wireless communication system may then hold (at 430) the PDP context associated with the mobile unit, while establishing (at 435) a session with the mobile unit according to the LTE/SAE session establishment information. In one embodiment, the mobile unit also retains the PDP context used for the previous session with the 2G/3G wireless communication system.

If the mobile unit hands off back to the 2G/3G wireless communication system, as indicated by the arrows 440, 445, then the PDP context information held by the LTE/SAE wireless communication system may be used to establish a session between the mobile unit and the 2G/3G wireless communication system. In the illustrated embodiment, the LTE/SAE wireless communication system provides (as indicated by the arrow 450) the PDP context (or information that may be used to derive the PDP context) to the 2G/3G wireless communication system. The session between the mobile unit and the 2G/3G wireless communication system may then be established (as indicated by the double arrows 455) using the PDP context that had been previously held (at 430) in the LTE/SAE wireless communication system. One drawback to this approach is that it may not be appropriate for situations in which the mobile unit establishes a new session and/or bearer while in the LTE/SAE wireless communication system.

FIG. 4B conceptually illustrates a fifth exemplary embodiment of a method 460 for determining session establishment information. In the illustrated embodiment, a mobile unit (or user equipment, UE) establishes a session with a wireless communication system that operates according to the legacy 2G/3G radio interface technology, as indicated by the double arrow 465. The mobile unit is subsequently handed off (at 470, 475) to the LTE/SAE wireless communication system. In response to the mobile unit handing off, the 2G/3G wireless communication system provides the 2G/3G session establishment information (e.g., the PDP context) associated with the mobile unit to the LTE/SAE wireless communication system, as indicated by the arrow 477. The LTE/SAE wireless communication system then determines (at 480) the appropriate session establishment information using the provided 2G/3G session establishment information and establishes (at 485) a session with the mobile unit.

In the fifth exemplary embodiment, the 2G/3G wireless communication system holds (at 490) the 2G/3G session establishment information (e.g., the PDP context) associated with the mobile unit after the mobile unit has been handed off to the LTE/SAE wireless communication system. In one embodiment, the mobile unit also retains the PDP context used for the previous session with the 2G/3G wireless communication system. If the mobile unit hands off back to the 2G/3G wireless communication system, as indicated by the arrows 491, 493, then the PDP context information held by the 2G/3G wireless communication system may be used to establish (at 495) a session between the mobile unit and the 2G/3G wireless communication system.

The fifth exemplary embodiment may in some cases be preferable to the fourth exemplary embodiment because this approach may make the LTE/SAE wireless communication system simpler and hide the 2G/3G system information from it. If the 2G/3G system uses the Iu-flex interface defined by the 3GPP, then the SGSN handling the mobile unit does not change. If Iu-flex is not used, then it is possible that the SGSN handling the new cell that contains the mobile unit after it returns to the 2G/3G wireless communication system may be different from the one that was previously serving the mobile unit in the 2G/3G wireless communication system. In that case, the SGSN may not have the PDP context information. In one embodiment, the LTE/SAE system may provide information to the new SGSN to identify the old SGSN and the UE context, e.g. the old Routing Area Identified (RAI) and Packet Temporary Mobile Station Identity (P-TMSI). The new SGSN can then contact the old SGSN to obtain the PDP context information using techniques similar to the inter-SGSN procedures used for Combined Cell-update/SRNC relocation procedures. This solution may be advantageous if a similar solution to retain the context in the old system is also chosen for handling inter-system mobility when the mobile unit is in idle modes such as LTE-Idle.

Although the exemplary embodiments discussed above with regard to FIGS. 2-4B have been discussed separately, persons of ordinary skill in the art should appreciate that they are not mutually exclusive. In alternative embodiments, portions of the exemplary embodiment depicted in FIGS. 2-4B may be combined to form further embodiments. Accordingly, the exemplary embodiment depicted in FIGS. 2-4B are to be interpreted as illustrative and should not be construed as limiting the present invention to the particular embodiments.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method involving at least one mobile unit configured to receive wireless connectivity using first and second wireless communication systems that operate according to first and second radio interface technologies, respectively, the first and second radio interface technologies being different, comprising:
determining, in response to said at least one mobile unit handing off from the first to the second wireless communication system, session establishment information for the second wireless communication system based on session establishment information associated with the first wireless communication system.

2. The method of claim 1, wherein the first wireless communication system operates according to a new or a legacy radio interface technology and the second wireless communication system operates according a legacy or a new radio interface technology, respectively.

3. The method of claim 1, wherein determining the session establishment information for the second wireless communication system comprises receiving information indicative of the session establishment information for the second wireless communication system from the first wireless communication system.

4. The method of claim 3, wherein receiving the information indicative of the session establishment information for the second wireless communication system from the first wireless communication system comprises receiving information indicative of the session establishment information for the second wireless communication system formed by the first wireless communication system in response to establishment of a first session between said at least one mobile unit and the first wireless communication system, the information indicative of the session establishment information for the second wireless communication system being formed based on information provided by said at least one mobile unit during establishment of the first session.

5. The method of claim 1, wherein determining the session establishment information for the second wireless communication system comprises mapping, at the second wireless communication system, the session establishment information for the first wireless communication system to the session establishment information for the second wireless communication system.

6. The method of claim 5, comprising at least one of:
providing the session establishment information for the second wireless communication system to said at least one mobile unit via the first wireless communication system; and
mapping, at said at least one mobile unit, the session establishment information for the first wireless communication system to the session establishment information for the second wireless communication system.

7. The method of claim 1, comprising:
determining session establishment information for the second wireless communication system;
transferring the session establishment information for the second wireless communication system to the first wireless communication system in response to said at least one mobile unit handing off from the second to the first wireless communication system; and
retaining the session establishment information for the second wireless communication system following handoff of said at least one mobile unit to the first wireless communication system, the session establishment information for the second wireless communication system being retained by at least one of the first and second wireless communication systems.

8. The method of claim 7, wherein determining the session establishment information for the second wireless communication system comprises accessing the retained session establishment information for the second wireless communication system in response to said at least one mobile unit handing off from the first to the second wireless communication system.

9. The method of claim 1, comprising establishing a second session between said at least one mobile unit and the second wireless communication system using the session establishment information for the second wireless communication system.

10. A method involving at least one mobile unit configured to receive wireless connectivity using first and second wireless communication systems that operate according to first and second radio interface technologies, respectively, the first and second radio interface technologies being different, comprising:
providing, from the first wireless communication system to the second wireless communication system and in response to said at least one mobile unit handing off from the first to the second wireless communication system, information indicative of session establishment information for the second wireless communication system.

11. The method of claim 10, wherein providing the information indicative of the session establishment information for the second wireless communication system comprises providing information indicative of the session establishment information for the second wireless communication system formed by the first wireless communication system in response to establishment of a first session between said at least one mobile unit and the first wireless communication system.

12. The method of claim 10, wherein providing the information indicative of the session establishment information for the second wireless communication system comprises providing the session establishment information for the first wireless communication system for mapping to the session establishment information for the second wireless communication system.

13. The method of claim 12, comprising receiving the session establishment information for the second wireless communication system from the second wireless communication system and providing the session establishment information for the second wireless communication system to said at least one mobile unit.

14. The method of claim 10, comprising receiving session establishment information for the second wireless communication system in response to said at least one mobile unit handing off from the second to the first wireless communication system while the session establishment information for the second wireless communication system is retained at the second wireless communication system.
